(19) United States
(12) Patent Application Publication
(10) Pub. No.: US 2016/0236145 A1
(43) Pub. Date: Aug. 18, 2016

(54) FLUE GAS TREATMENT METHOD AND DENITRATION/SO3 REDUCTION APPARATUS

(71) Applicant: MITSUBISHI HEAVY INDUSTRIES, LTD., Tokyo (JP)

(72) Inventors: Koji HIGASHINO, Tokyo (JP); Akihiro SAWATA, Tokyo (JP); Keiji FUJIKAWA, Tokyo (JP); Masanao YONEMURA, Tokyo (JP)

(73) Assignee: MITSUBISHI HEAVY INDUSTRIES, LTD., Tokyo (JP)

(21) Appl. No.: 14/888,112

(22) PCT Filed: Jun. 17, 2015
(86) PCT No.: PCT/JP2015/067449

§ 371 Date: Oct. 30, 2015

(30) Foreign Application Priority Data
Nov. 7, 2014 (JP) 2014-227577

(51) Int. Cl. B01D 53/86; B01D 53/90

(52) U.S. Cl. CPC B01D 53/8609; B01D 53/8628; B01D 53/90; B01D 2251/208; B01D 2255/1026; B01D 2255/40; B01D 2257/302; B01D 2257/404

(57) ABSTRACT

The present invention provides a flue gas treatment method and a denitration and SO₃ reduction apparatus configured to efficiently reduce the concentration of SO₃ in a combustion flue gas and also efficiently reduce NOₓ in the combustion flue gas at treatment costs lower than those of conventional methods. The flue gas treatment method performs a treatment for reducing SO₃ into SO₂ by adding a compound including the elements H and C to a combustion flue gas including SO₃ as well as NOₓ in an oxygen atmosphere as a first additive, and then by bringing the combustion flue gas into contact with a catalyst including an oxide constituted by one or more of elements selected from the group consisting of Ti, Si, Zr, and Ce and/or a mixed oxide and/or a complex oxide including two or more of the elements selected from the group as a carrier.

### TECHNICAL FIELD

The present invention relates to a flue gas treatment method and to a denitration and

SO₃ reduction apparatus, and more specifically relates to a flue gas treatment method and to a denitration and SO₃ reduction apparatus for treatment of a combustion flue gas including sulfur trioxide.

BACKGROUND ART

In recent years, a flue gas treatment method and a flue gas treatment apparatus for treating combustion flue gases generated from various combustion furnaces have been strongly desired in order to prevent air pollution. Such flue gases contain nitrogen oxides (NOₓ) and a large amount of sulfur oxides (SOₓ). In treating NOₓ, a method has been applied in which NOₓ is brought into contact with a denitration catalyst to be decomposed into nitrogen (N₂) and water (H₂O). Among SOₓ, sulfur trioxide (SO₃) is corrosive, and is a factor that inhibits the continuous long-term operation for treating flue gases due to clogging by ash inside flue gas treatment facilities such as an air preheater and an electric precipitator, dew point corrosion, and the like caused due to SO₃.

For a method of treating such SO₃, a method has been known in which ammonium (NH₃) is charged to a combustion flue gas, then the combustion flue gas is brought into contact with a denitration catalyst constituted by ruthenium (Ru) carried on titania (TiO₂), and thereby NOₓ is reduced and generation of SO₃ in combustion flue gases is prevented (e.g., Patent Literature 1). However, even in the exemplary case recited in Patent Literature 1, when ammonia is consumed by a denitration reaction in a treatment of denitrating a combustion flue gas, an oxidation reaction expressed by the following expression (1) predominantly progresses, and therefore the concentration of SO₃ may increase. In addition, although a method of reducing SO₃ in a combustion flue gas by using a reductant constituted by carbon monoxide (CO) and hydrocarbon has been known, but expensive iridium (Ir) is used in the catalyst (e.g., Patent literature 2).

### [Chemical Formula 1]

SO₂+1/2O₂→SO₃ (1)

### CITATION LIST

### Patent Literature

[Patent Literature 1] JP 3495591

[Patent Literature 2] JP 3495527

### SUMMARY OF INVENTION

### Technical Problem

Under these circumstances, an object of the present invention is to provide a flue gas treatment method and a denitration and SO₃ reduction apparatus that reduce treatment costs, reduce NOₓ contained in a combustion flue gas, and reduce the concentration of SO₃ more efficiently compared with prior art.

### Solution to Problem

In order to achieve the above-described object, according to an aspect of the present invention, a flue gas treatment method is provided, in which a 3C-5C olefinic hydrocarbon (unsaturated hydrocarbon) is added to a combustion flue gas including SO₃ as well as NOₓ as a first additive, and then the combustion flue gas is brought into contact with a catalyst which includes an oxide constituted by one or more of elements selected from the group consisting of Ti, Si, Zr, and Ce and/or a mixed oxide and/or a complex oxide constituted by two or more of elements selected from the group as a carrier but not including a noble metal, and thereby SO₃ is treated by reduction to SO₂.

In this aspect, it is made possible to denitrate NOₓ in the flue gas, prevent oxidation of SO₂, reduce the concentration of SO₃ during the treatment of the combustion flue gas, and reduce the costs for the material of the catalyst without having to use an expensive catalyst containing Ru and the like. In descriptions given herein and in the claims, the term “and/or” is used, as is provided by JIS Z 8301, to collectively express a combination of two terms used in parallel to each other and either one of the two terms, i.e. to collectively express the three possible meanings that can be expressed by the two terms.

It is preferable that the first additive be one or more selected from the group consisting of 2C-5C olefinic hydrocarbon (unsaturated hydrocarbon), 2C-5C paraffinic hydrocarbon (saturated hydrocarbons), alcohols, aldehydes, and aromatic compounds. Further, it is preferable that the 2C-5C olefinic hydrocarbon (unsaturated hydrocarbon) be one or more selected from the group consisting of C₂H₄, C₃H₆, C₄H₈, and C₅H₁₀. In addition, the C₄H₈ and C₅H₁₀ may be a geometric isomer or a racemic body of either one thereof.

By using the above-described additive, oxidation of SO₂ can be more efficiently suppressed and the concentration of SO₃ during the treatment of the combustion flue gas can be more efficiently reduced compared with the case of using NH₃ as the first additive.

It is preferable that the carrier include a mixed oxide and/or a complex oxide including one or more selected from the group consisting of TiO₂—SiO₂, TiO₂—ZrO₂, and TiO₂—CeO₂.

With the above-described carrier, the performance of reduction of SO₃ into SO₂ can be dramatically improved by using a mixed oxide and/or complex oxide with TiO₂ and with an amount of solid acid higher than a predetermined value.

In addition, the catalyst may be a catalyst in which a metal oxide including one or more selected from the group consisting of V₂O₅, WO₃, MoO₃, Mn₂O₃, MnO₂, NiO, and Co₃O₄ is carried on the complex oxide as the carrier. In addition, the catalyst may be a catalyst in which one or more selected from the group consisting of Ag, Ag₂O, and AgO carried on a carrier constituted by one or more selected from the group consisting of the oxide, the mixed oxide, and the complex oxide.

In addition, a metallosilicate-base complex oxide, in which at least a part of Al and/or Si in a zeolite crystal structure is substituted with one or more selected from the group consisting of Ti, V, Mn, Fe, and Co may be coated onto the catalyst.

With the above-described catalyst, SO₃ in the combustion flue gas can be reduced at a high reduction rate by using the first additive, and the SO₃ reduction reaction would not be inhibited even if NH₃ coexists.

It is preferable that NH₃ be added as a second additive simultaneously as the first additive is added and simultaneously perform the reduction of SO₃ and the denitration when performing a treatment for reducing SO₃ to SO₂.

In this aspect, the first additive can be added by partially reforming the ammonia supply line equipment provided to the existing denitration apparatus to contribute to reduction of SO₃ in the combustion flue gas.

It is preferable that the treatment for reducing SO₃ into SO₂ be performed in a temperature range of 250° C. to 450° C. . In addition, it is preferable that the treatment for reducing SO₃ into SO₂ be performed in a temperature range of 300° C. to 400° C.

By employing the temperature ranges, the treatment for reducing SO₃ in the combustion flue gas to SO₂ by using an existing denitration apparatus and under denitration treatment conditions for a high activity of the catalyst as a denitration catalyst.

According to another aspect of the present invention, the present invention is a denitration and SO₃ reduction apparatus. The denitration and SO₃ reduction apparatus according to the present invention includes a first injection device configured to obtain add a first additive to a combustion flue gas containing SO₃ as well as NOₓ; and a catalyst layer including a catalyst through which the combustion flue gas is allowed to flow, and in the denitration and SO₃ reduction apparatus, the first additive is a 3C-5C olefinic hydrocarbon (unsaturated hydrocarbon), the catalyst does not include a noble metal and includes an oxide including one or more of elements selected from the group consisting of Ti, Si, Zr, and Ce and/or a mixed oxide and/or a complex oxide including two or more of elements selected from the group as a carrier, and the SO₃ reduction apparatus is configured to perform a treatment for reducing SO₃ into SO₂.

According to another aspect of the present invention, the catalyst layer includes a first catalyst layer arranged on a back stream side of the first injection device and configured to reduce the concentration of SO₃; and a second catalyst layer arranged on a back stream side of a second injection device arranged close to the first injection device and configured to add NH₃ to the combustion flue gas as a second additive, the second catalyst layer being configured to perform denitration, and in this aspect, the first catalyst layer is arranged on a front stream side or a back stream side of the second catalyst layer.

### ADVANTAGEOUS EFFECTS OF INVENTION

According to the present invention, a flue gas treatment method and a denitration and SO₃ reduction apparatus are provided which are configured to denitrate NOₓ in the combustion flue gas and reduce the concentration of SO₃ in the combustion flue gas at the same time at treatment costs lower than those conventionally.

### BRIEF DESCRIPTION OF DRAWINGS

FIG. 1 is a schematic diagram showing a denitration and SO₃ reduction apparatus according to the present invention, which is a first embodiment.

FIG. 2 is a schematic diagram showing a denitration and SO₃ reduction apparatus according to the present invention, which is a second embodiment.

FIG. 3 is a schematic diagram showing a denitration and SO₃ reduction apparatus according to the present invention, which is a third embodiment.

FIG. 4 is a graph showing variation of the concentration of SO₃ in a combustion flue gas in Example 1 of the present invention.

FIG. 5 is a graph showing variation of the concentration of SO₃ in a combustion flue gas in Example 2 of the present invention.

FIG. 6 is a graph showing a rate of reduction of SO₃ in a combustion flue gas and a denitration rate in Example 2 of the present invention.

FIG. 7 is a graph showing a rate of reduction of SO₃ and a denitration rate obtained by using a catalyst of Example 3 of the present invention.

FIG. 8 is a graph showing a relationship between a solid acid amount and an SO₃ reduction rate in Example 3 of the present invention.

FIG. 9 is a graph showing a rate of reduction of SO₃ and a denitration rate obtained by using a catalyst of Example 4 of the present invention.

FIG. 10 is a graph showing a rate of reduction of SO₃ obtained by using a catalyst of Example 5 of the present invention.

FIG. 11 is a graph showing a denitration rate obtained by using the catalyst of Example 5 of the present invention.

### DESCRIPTION OF EMBODIMENTS

A denitration and SO₃ reduction apparatus and a flue gas treatment method according to the present invention will be described below with reference to embodiments shown in the attached drawings. A flue gas generated by combusting an oil-derived fuel or a coal-derived fuel in a boiler and in an oxygen atmosphere will be herein referred to as a “combustion flue gas”. In addition, the stream of gas will be herein referred to as a “front stream” or “back stream” in relation to the direction of flow of a combustion flue gas.

### [Denitration and SO₃ Reduction Apparatus]

### First Embodiment

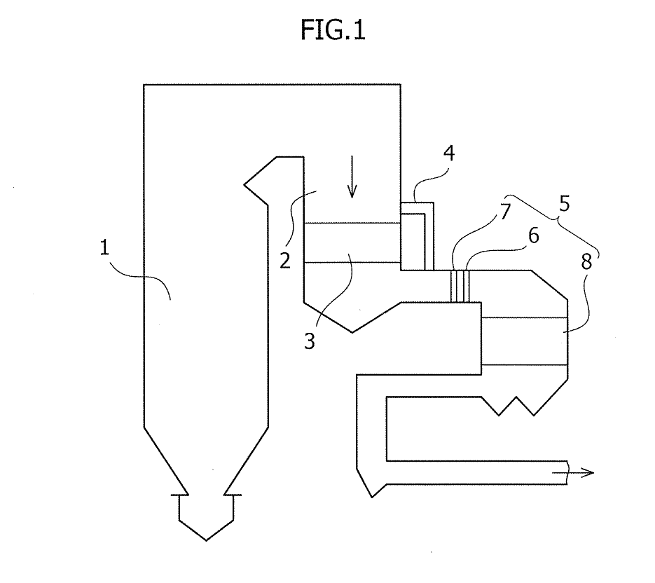

FIG. 1 shows a first embodiment, in which the denitration and SO₃ reduction apparatus according to the present invention is arranged on a back stream side of a boiler. Referring to FIG. 1, a denitration and SO₃ reduction apparatus 5 is arranged on a back stream side of a flue gas chimney 2 of a boiler which generates a flue gas in the furnace 1.

The boiler burns an externally supplied fuel in the furnace 1 and discharges a combustion flue gas generated by the burning into the flue gas chimney 2. The denitration and SO₃ reduction apparatus 5, which is arranged on a back stream side of the flue gas chimney 2, simultaneously performs a NOₓ denitration treatment and an SO₃ reduction treatment for the combustion flue gas that flows through the flue gas chimney 2. In the descriptions given herein and in the claims, the treatment for reducing SO₃ into SO₂ will be referred to as the “SO₃ reduction treatment”.

An ECO 3, which is arranged in the combustion flue gas chimney 2 in which the combustion flue gas is circulated, performs heat exchange between boiler feed water and the combustion flue gas that flow through the inside of the ECO 3. More specifically, the ECO 3 increases the temperature of the boiler feed water by using the thermal inertia of the combustion flue gas and thereby improves the efficiency of combustion in the boiler. An ECO bypass 4 is arranged so that one end thereof is in communication with the front stream side of the ECO 3 and the other end thereof is in communication with the back stream side of the ECO 3, and feeds the combustion flue gas before being fed into the ECO 3 to the side of an inlet of the denitration and SO₃ reduction apparatus 5, bypassing the ECO 3. In addition, the ECO bypass 4 controls the temperature of the combustion flue gas to be fed into the denitration and SO₃ reduction apparatus 5 within a predetermined temperature range appropriate for denitration and reduction reactions.

The denitration and SO₃ reduction apparatus 5 is arranged in the combustion flue gas chimney 2, and at least includes a first injection device 6, a second injection device 7, and a catalyst layer 8. The denitration and SO₃ reduction apparatus 5 adds a first additive and a second additive to the flue gas and allows the combustion flue gas including the additives to flow through the catalyst layer 8. The denitration and SO₃ reduction apparatus 5 performs an SO₃ reduction treatment by using the catalyst layer 8, the first injection device 6, and the second injection device 7. It is preferable that the denitration and SO₃ reduction apparatus 5 be configured so as to add the first additive and the second additive at the same time.

The first injection device 6 is arranged on a front stream side of the denitration and SO₃ reduction apparatus 5 and on a back stream side of the ECO bypass 4, and adds the first additive to the combustion flue gas including SO₃ as well as NOₓ. More specifically, the first injection device 6 collaborates with the catalyst layer 8 to reduce SO₃ in the combustion flue gas.

The first additive injected from the first injection device 6 is an SO₃ reductant primarily for reduction of SO₃ into SO₂, and hydrocarbon constituted by carbon element (C) and/or hydrogen element having a capability of reducing SO₃ in an oxygen atmosphere can be used. More specifically, the first additive is an additive constituted by one or more selected from the group consisting of: an olefinic hydrocarbon (unsaturated hydrocarbon) expressed by a general formula: CₙH₂ₙ (n is an integer of 2 to 5), a paraffinic hydrocarbon (saturated hydrocarbon) expressed by a general formula: CₘH₂ₘ₊₂ (m is an integer of 2 to 5), alcohols such as methanol (CH₃OH) and ethanol (C₂H₅OH), aldehydes such as acetaldehyde (CH₃CHO) and propionaldehyde (C₂H₅CHO), and aromatic compounds such as toluene (C₆H₅CH₃) and ethyl benzene (C₆H₅C₂H₅).

For the 2C-5C olefinic hydrocarbon (unsaturated hydrocarbon), it is preferable to use one or more selected from the group consisting of C₂H₄, C₃H₆, C₄H₈, and C₅H₁₀, and it is more preferable to use one or more selected from the group consisting of ≧3C olefinic hydrocarbons including C₃H₆, C₄H₈, and C₅H₁₀. For the C₄H₈ and C₅H₁₀, a geometric isomer or a racemic body of either one of them can be used. Examples of ≧4C unsaturated hydrocarbons include 1-butene (1-C₄H₈); 2-butenes (2-C₄H₈) such as cis-2-butene and trans-2-butene; isobutene (iso-C₄H₈); 1-pentene (1-C₅H₁₀); and 2-pentenes (2-C₅H₁₀) such as cis-2-pentene and trans-2-pentene. With this configuration, by reactions expressed by the following expressions (2) to (8), the present invention can contribute to the reduction of SO₃ in an oxygen atmosphere and reduce the concentration of SO₃ in the combustion flue gas.

### [Chemical Formula 2]

SO₃+CH₃OH+3/4O₂→SO₂+1/2CO+1/2CO₂+2H₂O (2)

SO₃+C₂H₅OH+5/42O₂→SO₂ +CO+CO₂+2/5H₂O (3)

SO₃+C₂H₄+5/2O₂→SO₂+CO+CO₂+2H₂O (4)

SO₃+3/2C₃H₆+41/83O₂→SO₂+9/4CO+9/4CO₂+6H₂O (5)

SO₃+3/2C₃H₈+63/8O₂→SO₂+9/4CO+9/4CO₂+6H₂O (6)

SO₃+3/2C₄H₈+13/2O₂→SO₂+3CO+3CO₂+6H₂O (7)

SO₃+C₅H₁₀+23/4O₂→SO₂+5/2CO+5/2CO₂+5H₂O (8)

If C₃H₆ is used as the first additive, it is useful if the load of the first additive be 0.1 to 2.0 by molar ratio. If the molar ratio of the first additive is less than 0.1, the oxidation of SO₂ may become predominant and thus SO₃ may increase, and in contrast, if the molar ratio of the first additive is more than 2.0, then a large amount of unreacted excessive C₃H₆ may be discharged. By controlling the amount of the first additive in the above-described range, the performance of eliminating SO₃ in the combustion flue gas can be improved. The effect of removing SO₃ can be obtained outside the range specified above.

The second injection device 7 is arranged close to the first injection device 6, and adds NH₃ to the combustion flue gas as the second additive. The second injection device 7 is arranged on a front stream side of the denitration and SO₃ reduction apparatus 5 and on a back stream side of the ECO bypass 4, and injects the second additive for denitration of NOₓ to the combustion flue gas. The second injection device 7 collaborates with the catalyst layer 8 to denitrate NOₓ.

The catalyst layer 8 is constituted by a catalyst which denitrates the combustion flue gas. It is preferable that the shape of the catalyst arranged in the catalyst layer 8 be a honeycomb shape so that the catalyst can efficiently function also as a denitration catalyst and reduce the pressure drop that may occur during treatment of the combustion flue gas. The honeycomb structure is not limited to a structure with a rectangular section, and can include various shapes such as circular, elliptical, triangular, pentagonal, and hexagonal shapes.

The catalyst arranged in the catalyst layer 8 is a catalyst in which the active component is carried on a carrier which is an oxide, a mixed oxide, and/or a composite oxide. More specifically, examples of the carrier include an oxide of one or more of elements selected from the group consisting of titanium (Ti), silicon (Si), zirconium (Zr), and cerium (Ce) and/or a mixed oxide and/or a composite oxide of two or more of elements selected from the above group. In other words, the carrier at least includes the following form.
An oxide constituted by one or more of titania (TiO₂), silica (SiO₂), zirconia (ZrO₂), and cerium oxide (Ce₂O₃)
A mixed oxide or a complex oxide constituted by two, three, or four of titanium (Ti), silicon (Si), zirconium (Zr) and cerium (Ce)
A mixture constituted by two, three, or four of the above oxide
A mixture of one of the above mixtures and one of the above mixed oxides or complex oxides

Among them, the mixed oxide or the complex oxides selected from the group consisting of TiO₂—SiO₂, TiO₂—ZrO₂, and TiO₂-CeO₂ is preferable, and the complex oxides selected from the above group is more preferable.

The complex oxide can be prepared by a process in which an alkoxide compound, a chloride, a sulfate, or an acetate of the above-described elements is mixed, then the resulting mixture is further mixed with water and then stirred in the form of an aqueous solution or sol for hydrolysis. The complex oxide may also be prepared by a known coprecipitation process instead of the above-described sol-gel process.

The active component is a metal oxide constituted by one or more selected from the group consisting of vanadium oxide (V₂O₅), tungsten oxide (WO₃), molybdenum oxide (MoO₃), manganese oxide (Mn₂O₃), manganese dioxide (MnO₂), nickel oxide (NiO), and cobalt oxide (Co₃O₄). The active component may be one or more selected from the group consisting of silver (Ag), silver oxide (Ag₂O), and silver monoxide (AgO). With this configuration, an active metal carried by the catalyst acts as an active site, and thus the denitration of NOₓ such as NO and NO₂ can be efficiently performed in an oxygen atmosphere and the reduction of SO₃ in an excess oxygen atmosphere can be performed. It is preferable that the active component, among these metal oxides, include tungsten oxide (WO₃).

In addition, for the catalyst, a catalyst prepared by coating or impregnating a metallosilicate-base complex oxide in which at least a part of the aluminum element (Al) and/or silicon element (Si) in a zeolite crystal structure is substituted with one or more selected from the group consisting of titanium element (Ti), vanadium element (V), manganese element (Mn), iron element (Fe), and cobalt element (Co). The above-described metallosilicate can be prepared by using a hydrothermal synthesis method in which at least a part of water glass and silicon element that are the silicon source are mixed with a source of metal element to be replaced and a structure directing agent, and the mixture is placed in an autoclave and processed by using the hydrothermal synthesis method under a high temperature and high pressure.

### [Flue Gas Treatment Method]

A first embodiment of the flue gas treatment method according to the present invention will be described by describing its mode of operation of the denitration and SO₃ reduction apparatus according to the above-described first embodiment. The flue gas treatment method of the present embodiment at least performs an SO₃ reduction treatment.

In the SO₃ reduction treatment, the first additive for reducing SO₃ and NH₃ that is the second additive for reducing NOₓ are injected from the first injection device 6 and the second injection device 7 to the combustion flue gas including SO₃ as well as NOₓ on a front stream thereof. By allowing the combustion flue gas including the charged additives to flow through the catalyst layer 8 constituted by the denitration catalyst on a back stream side thereof, the NOₓ denitration treatment and the SO₃ reduction treatment are carried out at the same time. In the treatment, it is preferable that the first additive and the second additive be added to the combustion flue gas at the same time.

It is preferable that the SO₃ reduction treatment be carried out in a temperature range of 250° C. to 450° C., and it is more preferable to carry out the SO₃ reduction treatment in a temperature range of 300° C. to 400° C. If the SO₃ reduction treatment is carried out at a temperature below 300° C., the denitration treatment may not be sufficiently completed, and in contrast, if the SO₃ reduction treatment is carried out at a temperature above 400° C., the reduction of SO₃ may not be sufficient.

According to the present embodiment, NOₓ in the combustion flue gas including SO₃ and/or NOₓ generated when burned in the boiler can be removed by denitration, oxidation of SO₂ can be prevented, and thus the concentration of SO₃ can be reduced during treatment of the combustion flue gas, and addition, costs for the material of the catalyst can be reduced because no expensive catalyst is used. Further, the above-described effect of the present embodiment can be achieved merely by additionally installing a first injection device configured to inject the first additive for reducing SO₃ on a front stream side of an existing denitration apparatus. Accordingly, the SO₃ reduction treatment can be carried out at low cost.

### [Denitration and SO₃ Reduction Apparatus]

### Second Embodiment

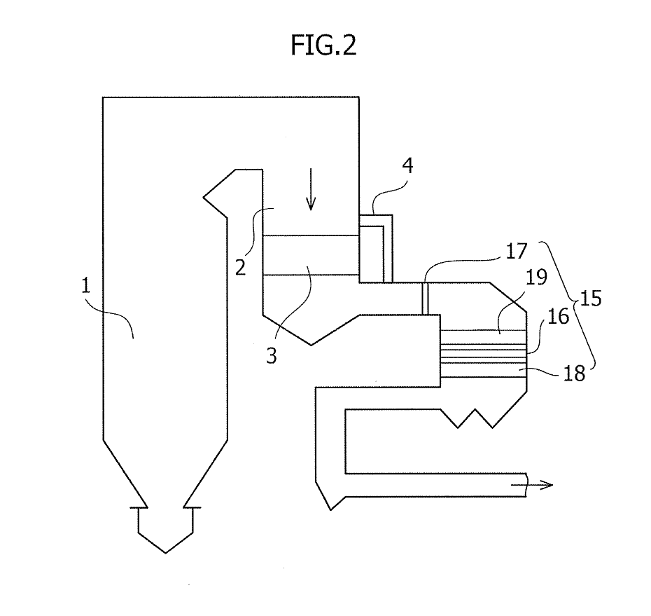

A second embodiment of the denitration and SO₃ reduction apparatus according to the present invention will be described in detail with reference to FIG. 2. In the present embodiment, the components that are the same as those of the above-described first embodiment of the denitration and SO₃ reduction apparatus will be provided with the same reference numerals and symbols, and detailed descriptions thereof will not be repeated. A denitration and SO₃ reduction apparatus 15 according to the present embodiment includes a catalyst layer segmented into a first catalyst layer and a second catalyst layer and a first injection device is arranged between them, and the denitration and SO₃ reduction apparatus 15 is different from the denitration and SO₃ reduction apparatus 5 according to the above-described first embodiment at this point.

Referring to FIG. 2, the denitration and SO₃ reduction apparatus 15 is arranged in the combustion flue gas chimney 2, and at least includes s first injection device 16 configured to add the first additive to the combustion flue gas; a second injection device 17 configured to add the second additive to the combustion flue gas; and a catalyst layer a catalyst configured to denitrate the combustion flue gas. The catalyst layer is constituted by a first catalyst layer 18 configured to reduce the concentration of SO₃ and a second catalyst layer 19, which is arranged on a front stream side of the first catalyst layer 18 and configured to perform denitration. The denitration and SO₃ reduction apparatus 15 adds the second additive from the second injection device 17 to the combustion flue gas that enters therein from the flue gas chimney 2, and then allows the combustion flue gas containing the second additive to flow through the second catalyst 19. In addition, the denitration and SO₃ reduction apparatus 15 adds the first additive from the first injection device 16 to the combustion flue gas that has gone through the second catalyst 19 and then allows the combustion flue gas containing the first additive to flow through the first catalyst layer 18.

The first injection device 16 is arranged in the combustion flue gas chimney 2 on a front stream side of the first catalyst layer 18 and on a back stream side of the second catalyst layer 19. The first catalyst layer 18 is arranged on a back stream side of the second catalyst layer 19. In addition, the first injection device 16 injects the first additive for reducing the concentration of SO₃ to the combustion flue gas.

The second injection device 17 is arranged in the combustion flue gas chimney 2 on a front stream side of the second catalyst layer 19. In addition, the second injection device 17 injects the second additive for denitration of NOₓ to the combustion flue gas. For the second injection device 17 and the second catalyst layer 19, a denitration apparatus installed in an existing plant can be employed, for example.

For the first additive injected from the injection device 16 and the catalyst installed in the catalyst layer 18, an additive and a catalyst similar to those of the first embodiment can be applied. For the second additive injected from the injection device 17 and the catalyst installed in the second catalyst layer 19, not only an additive and a catalyst similar to those of the first embodiment but also a publicly known catalyst (e.g., V₂O₅—TiO₂) can be applied.

### [Flue Gas Treatment Method]

A second embodiment of the flue gas treatment method according to the present invention will be described by describing a mode of operation of the above-described second embodiment of the denitration and SO₃ reduction apparatus. The flue gas treatment method of the present embodiment at least performs an SO₃ reduction treatment.

In the SO₃ reduction treatment, as a pretreatment to a combustion flue gas at least including NOₓ and SO₃, NH₃ that is the second additive is added from the second injection device 17 to the combustion flue gas, and the combustion flue gas is brought into contact with the denitration catalyst in the second catalyst 19 arranged on a back stream side of the second injection device 17. Then, as a posttreatment, an additive for SO₃ is added from the first injection device 16 to the combustion flue gas, and the combustion flue gas is brought into contact with the catalyst for SO₃ in the first catalyst layer 18 arranged on a back stream side of the first injection device 16.

For the treatment temperature for the SO₃ reduction treatment, temperature ranges similar to those of the first embodiment can be employed.

According to the denitration and SO₃ reduction apparatus and the flue gas treatment method of the second embodiment, SO₃ can be more efficiently treated on a back stream side of the existing denitration apparatus, and in addition, the catalyst can be easily exchanged according to degradation of the function of the catalyst used for the denitration and the reduction of SO₃, respectively.

[Denitration and SO₃ reduction Apparatus]

### (Third Embodiment)

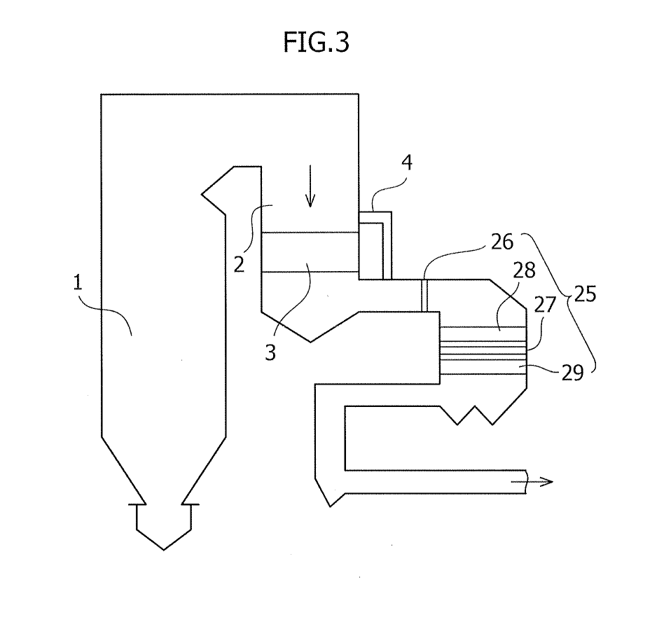

A third embodiment of the denitration and SO₃ reduction apparatus according to the present invention will be described in detail with reference to FIG. 3. In the present embodiment, the components that are the same as those of the first and the second embodiments are provided with the same reference numerals and symbols, and detailed descriptions thereof will not be repeated. A denitration and SO₃ reduction apparatus 25 according to the present embodiment is different from the denitration and SO₃ reduction apparatus 15 according to the second embodiment in such a point that a first injection device and a first catalyst layer are arranged on a front stream side of a second injection device and a second catalyst layer.

Referring to FIG. 3, the denitration and SO₃ reduction apparatus 25 is arranged in the combustion flue gas chimney 2, and at least includes a first injection device 26, a second injection device 27, a first catalyst layer 28, and a second catalyst layer 29. The denitration and SO₃ reduction apparatus 25 adds a second additive from the first injection device 26 to a combustion flue gas that enters from the flue gas chimney 2, and then allows the combustion flue gas containing the second additive to flow through the first catalyst layer 28. In addition, the denitration and SO₃ reduction apparatus 25 adds the second additive from the second injection device 27 to the combustion flue gas that has flown through the first catalyst layer 28, and then allows the combustion flue gas containing the second additive to flow through the second catalyst layer 29.

The first injection device 26 is arranged in the combustion flue gas chimney 2 on a front stream side of the first catalyst layer 28 and on a front stream side of the second catalyst layer 29. The first catalyst layer 28 is arranged on a front stream side of the second catalyst layer 29. The first injection device 26 injects the first additive for reducing the concentration of SO₃ to the combustion flue gas. The second injection device 27 is arranged in the combustion flue gas chimney 2 on a front stream side of the second catalyst layer 29. In addition, the second injection device 27 injects the second additive for denitration of NOₓ to the combustion flue gas. Similarly to the second embodiment, for the second injection device 27 and the second catalyst layer 29 also, a denitration apparatus installed in an existing plant can be applied.

For the first additive injected from the injection device 26 and the catalyst installed in the catalyst layer 28, an additive and a catalyst similar to those of the first and the second embodiments can be applied. In addition, for the second additive injected from the injection device 27 and the catalyst installed in the second catalyst layer 29 also, not only an additive and a catalyst similar to those of the first embodiment but also a publicly known denitration catalyst (e.g., V₂O₅—TiO₂) can be applied.

### [Flue Gas Treatment Method]

A third embodiment of the flue gas treatment method according to the present invention will be described by describing a mode of operation of the denitration and SO₃ reduction apparatus according to the above third embodiment. The flue gas treatment method of the present embodiment at least performs a SO₃ reduction treatment.

In the SO₃ reduction treatment, as a pretreatment to a combustion flue gas at least including NOₓ and SO₃, an additive for SO₃ is added from the first injection device 26, and the combustion flue gas is brought into contact with the catalyst for SO₃ in the first catalyst layer 28 arranged on a back stream side of the first injection device 26. Then, as a posttreatment, NH₃ is added from the second injection device 27 to the combustion flue gas as the second additive, and the combustion flue gas is brought into contact with the denitration catalyst in the second catalyst 29 arranged on a back stream side of the second injection device 27.

For the treatment temperature for the SO₃ reduction treatment, temperature ranges similar to those of the first and the second embodiments can be employed.

According to the denitration and SO₃ reduction apparatus and the flue gas treatment method of the third embodiment, SO₃ can be more efficiently treated on a back stream side of the existing denitration apparatus, and in addition, the catalyst can be easily exchanged according to degradation of the function of the catalyst used for the denitration and the reduction of SO₃, respectively.

### EXAMPLES

The effects of the present invention will be clarified by more specifically describing the present invention with reference to examples. The flue gas treatment method and the denitration and SO₃ reduction apparatus according to the present invention are not limited by the following examples by any means.

### Example 1

By using a different catalyst, the effect of the first additive (SO₃ reductant) for reducing SO₃ into SO₂ were examined.

### (Preparation of Catalyst A)

A catalyst A including ruthenium (Ru), which functions as a catalyst for reducing SO₃ into SO₂, was prepared. An aqueous solution of ruthenium chloride (RuCl₃) was impregnated with an anatase type titania powder including 10 wt. % tungsten oxide (WO₃) per 100 wt. % titania (TiO₂), thereby 1 wt. % Ru was carried on the powder per 10.0 wt. % of anatase type titania powder, and the resultant was evaporated and dried. Then the residue was fired at 500° C. for 5 hours, and the obtained powder was used as the catalyst A.

(Preparation of Catalyst B)

A catalyst B was prepared as a typical catalyst having a denitration function by ammonia. Ti(O-iC₃H₇)₄, a Ti alkoxide, and Si(OCH₃)₃, a Si alkoxide, were mixed at a ratio of 95:5 (wt. %) (as TiO₂, SiO₂, respectively), the mixture was added to 80° C. water for hydrolysis, then the reaction mixture was stirred and matured, the produced sol was filtered, and the obtained gelled product was washed, dried, and heated and fired at 500° C. for 5 hours to obtain a powder of TiO₂—SiO₂ complex oxide (TiO₂—SiO₂ powder). Ammonium metavanadate (NH₃VO₃) and ammonium paratungstate ((NH₄)₁₀H₁₀W₁₂O₄₆.6H₂O) were impregnated into the complex oxide by using a 10 wt. % aqueous solution of methylamine, 0.6 wt. % V₂O₅ and 8 wt. % WO₃ were carried per 100 wt. % complex oxide, the resultant was evaporated and dried, and then heated and fired at 500° C. for 5 hours. The obtained powder was used as the catalyst B.

### (Preparation of Catalyst C)

A catalyst C, a typical catalyst having a function of denitration by ammonia, was prepared. Ti(O-iC₃H₇)₄, a Ti alkoxide, and Zr(Oi-C₄h₉)₄, a Zr alkoxide, were mixed at a ratio of 95:5 (wt. %) (as TiO₂, ZrO₂, respectively), the mixture was added to 80° C. water for hydrolysis, then the reaction mixture was stirred and matured, the produced sol was filtered, and the obtained gelled product was washed, dried, and heated and fired at 500° C. for 5 hours to obtain a powder of TiO₂—ZrO₂ complex oxide (TiO₂-ZrO₂ powder). Ammonium paratungstate ((NH₄)₁₀H₁₀W₁₂O₄.6H₂O) was impregnated into the complex oxide by using a 10 wt. % aqueous solution of methylamine, 8 wt. % WO₃ was carried per 100 wt. % complex oxide, the resultant was evaporated and dried, and then heated and fired at 500° C. for 5 hours. The obtained powder was used as the catalyst C.

### (Preparation of Catalyst D)

A catalyst D containing titania (TiO₂) only was prepared. A powder of anatase type titania of the same amount as the catalyst A was fired at 500° C. for 5 hours to prepare a powder of catalyst D.

### (Preparation of Test Examples 1 to 5)

80 wt. % of water was added respectively to 20 wt. % of catalysts A to D, and the mixture was pulverized by wet ball mill to obtain wash coat slurry. Then a monolith base material (pitch: 7.4 mm, wall thickness: 0.6 mm) produced by Cordierite was coated with the slurry by dipping, and the obtained product was dried at 120° C. and then fired at 500° C. The amount of the coating was 100 g per surface area of 1 m² of the base material. A case of using the catalyst A and ammonia (NH₃) was used as the SO₃ reductant was used as Test Example 1. On the other hand, a case of using the catalyst A and propylene (C₃H₆) was used as the SO₃ reductant was used as Test Example 2. A case of using the catalyst B and C₃H₆ was used as the SO₃ reductant was used as Test Example 3. A case of using the catalyst C and C₃H₆ as the SO₃ reductant was used as Test Example 4. In addition, a case of using the catalyst D and C₃H₆ as the SO₃ reductant was used as Test Example 5.

### (SO₃ Removal Test I)

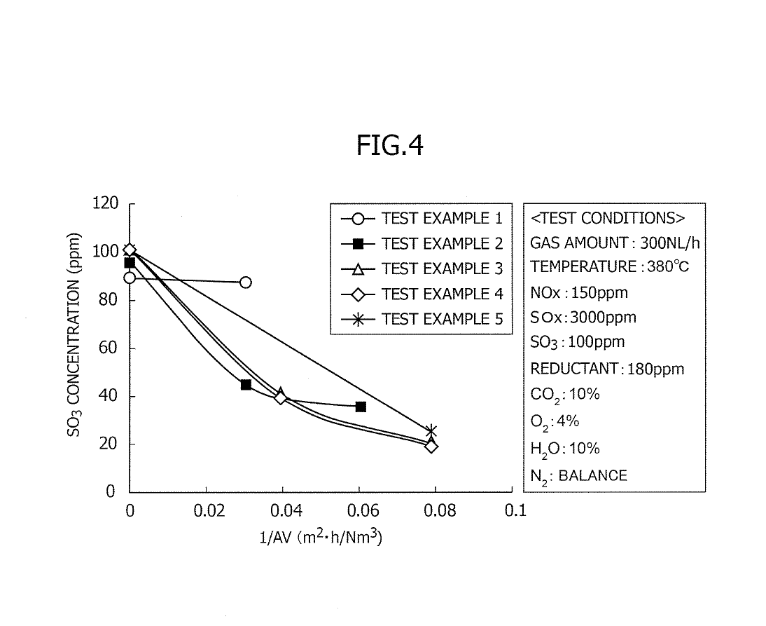

By bench-scale testing in which an actual machine is assumed, the SO₃ reductant was added to the combustion flue gas, and the combustion flue gas containing the SO₃ reductant was allowed to flow through the catalyst of the respective Test Examples installed in the denitration and SO₃ reduction apparatus, and thereby variation of the concentration of SO₃ (ppm) in the combustion flue gas in terms of 0.03 to 0.8 (1/AV (m²·h/Nm³) after the combustion flue gas had flowed through the catalyst layer was examined. The test results and the test conditions are shown in FIG. 4. The concentration of SO₃ was analyzed by a deposition titration method after the sampling was done. In the drawing, “AV” denotes the area velocity (total contact area by gas amount/catalyst), and “1/AV” means the total contact area of the catalyst in relation to the gas amount. The unit of 1/AV is denoted as m²·h/Nm³.

FIG. 4 shows variation of the concentration of SO₃ (ppm) in terms of 0.03 to 0.08 m²·h/Nm³ in Test Examples 1 to 5. Referring to FIG. 4, in Test Example 1, the concentration of SO₃ at the inlet of the catalyst layer did not substantially vary. In Test Example 2, the concentration of SO₃ at the inlet of the catalyst layer decreased from about 100 ppm to about 40 ppm at 0.06 m²·h/Nm³. On the other hand, in Test Example 3, the concentration of SO₃ at the inlet of the catalyst layer decreased from about 100 ppm to about 20 ppm at 0.08 m²·h/Nm³. In Test Example 4, the concentration of SO₃ at the inlet of the catalyst layer decreased from about 100 ppm to about 20 ppm at 0.08 m²·h/Nm³. In addition, also in Test Example 5, the concentration of SO₃ at the inlet of the catalyst layer decreased from about 100 ppm to about 25 ppm at 0.08 m²·h/Nm³.

It was observed that in Test Example 1 in which the catalyst A containing Ru was used and NH₃ was used as the SO₃ reductant, the concentration of SO₃ at the inlet of the catalyst layer did not substantially vary. It was observed that in Test Example 2 in which the catalyst A containing Ru was used and C₃H₆ was used as the SO₃ reductant, the concentration of SO₃ in the combustion flue gas decreased. In addition, it was observed that in Test Example 3 using the catalyst B not including expensive Ru, by using C₃H₆ as the SO₃ reductant, the concentration of SO₃ in the combustion flue gas remarkably decreased. In addition, it was observed that in Test Example 4 using the catalyst C, by using C₃H₆ as the SO₃ reductant, the concentration of SO₃ in the combustion flue gas remarkably decreased. Furthermore, it was observed that also in Test Example 5 using the catalyst D, by using C₃H₆ as the SO₃ reductant, the concentration of SO₃ in the combustion flue gas remarkably decreased. From these results, it was found that by using C₃H₆ as the SO₃ reductant, concentration of SO₃ in the combustion flue gas could be reduced.

It was found that instead of using the catalyst A including Ru, by using a hydrocarbon including hydrogen element (H) and carbon element (C) such as C₃H₆, concentration of SO₃ in the combustion flue gas at the inlet of the catalyst layer could be reduced more even if a normal denitration catalyst was used, compared with the case of using NH₃ as the SO₃ reductant. Next, based on the elementary reaction model on the surface of the catalyst described in the following items 1 to 4, it was estimated that to obtain these results, sulfonation occurring due to the reaction on the catalyst between the matter obtained by decomposition of hydrocarbon and SO₃ was important.

1. Hydrocarbon adsorption reaction

Hydrocarbon (CₓH_{y})+surface→CₓH_{y}−surface

2. Hydrocarbon decomposition reaction (hydrogen abstraction reaction)

CₓH_{y}−surface→CₓH_{y-1}(surface-coordination)+H−surface

3. Reaction with SO_{3(g)}(conversion into sulfonic acid)

CₓH_{y-1}(surface-coordination)+SO_{3(g)}→SO₂+CₓH_{y-1}—SO₃₋H₋ surface)

4. Decomposition of SO₃

CₓH_{y-1}—SO₃₋H₋ surface→SO₂+CO₂+CO

### Example 2

By using a hydrocarbon with a different composition as the first additive (SO₃ reductant), the effect of reducing SO₃ into SO₂ depending on the composition of the 2 0 hydrocarbon compound was examined.

### (Preparation of Test Examples 6 to 10)

Similarly to Example 1, the catalyst B was coated on a monolith base material produced by Cordierite. The amount of the coating was 100 g per surface area of 1 m² of the base material. The case in which C₃H₆ was used as the SO₃ reductant was used as Test Example 6, the case in which propane (C₃H₈) was used as the SO₃ reductant was used as Test Example 7, the case in which methanol (CH₃OH) was used as the SO₃ reductant was used as Test Example 8, and the case in which ethanol (C₂H₅OH) was used as the SO₃ reductant was used as Test Example 9. In addition, for comparison with the other Test Examples, the case in which ammonia (NH₃) was used as the SO₃ reductant was used as Test Example 10.

(SO₃ removal Test II)

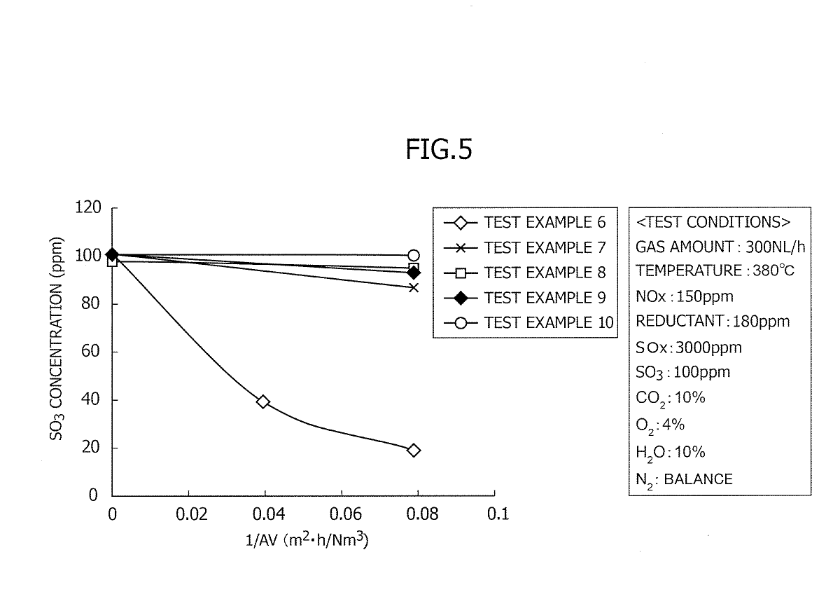

Similarly to Example 1, the SO₃ reductant was added to the combustion flue gas, and the combustion flue gas containing the SO₃ reductant was allowed to flow through the catalyst layer using the SO₃ catalyst installed in the denitration and SO₃ reduction apparatus, and thereby variation of the concentration of SO₃ in the combustion flue gas at 0.04 to 0.08 m²·h/Nm³ after the combustion flue gas had flowed through the catalyst layer. The variation of the concentration of SO₃ before and after the combustion flue gas had flowed through the catalyst layer was examined. The test conditions were the same as those of Example 1. The test results and the test conditions are shown in FIG. 5.

FIG. 5 shows variation of the concentration of SO₃ (ppm) in the combustion flue gas at 0.04 to 0.08 m²·h/Nm³ in Test Examples 6 to 10. Referring to FIG. 5, in Test Examples 6 to 9, the concentration of SO₃ in the combustion flue gas at the inlet of the catalyst layer decreased. In contrast, in Test Example 10, the concentration of SO₃ in the combustion flue gas at the inlet of the catalyst layer did not decrease. In Test Examples 5 and 6 in which C₃H₆ and C₃H₈ were used as the SO₃ reductant, the concentration of SO₃ in the combustion flue gas decreased more compared with the Test Examples 8 and 9 in which CH₃OH and C₁H₅OH were used as the SO₃ reductant. In addition, in Test Example 6 in which C₃H₆ was used as the SO₃ reductant, the effect of reducing the concentration of SO₃ was the most remarkable.

Then, further, by using a hydrocarbon having a different composition as the first additive (SO₃ reductant), the effect of reducing SO₃ into SO₂ and the denitration effect depending on the composition of the hydrocarbon compound were examined.

### (Preparation of Catalyst E)

A catalyst E was prepared in a similar manner as the case of preparing the catalyst B except that the ratio of TiO₂ and SiO₂ was changed to 88:12 (wt. %), that the amount of V₂O₅ was 0.3 wt. %, and that the amount of WO₃ was 9 wt. %.

### (Preparation of Test Examples 11 to 18)

Similarly to Example 1, the catalyst E was coated onto the monolith base material produced by Cordierite. The case in which methanol (CH₃OH) was used as the SO₃ reductant was used as Test Example 11, the case in which ethanol (C₂H₅OH) was used as the SO₃ reductant was used as Test Example 12, and the case in which propane (C₃H₈) was used as the SO₃ reductant was used as Test Example 13. In addition, the case in which ethylene (C₂H₄) was used as the SO₃ reductant was used as Test Example 14, the case in which propylene (C₃H₆) was used as the SO₃ reductant was used as Test Example 15, the case in which 1-butene (1-C₄H₈) was used as the SO₃ reductant was used as Test Example 16, the case in which 2-butene (2-C₄H₈) was used as the SO₃ reductant was used as Test Example 17, the case in which isobutene (iso-C₄H₈) was used as the SO₃ reductant was used as Test Example 18.

### (SO₃ Removal Test III)

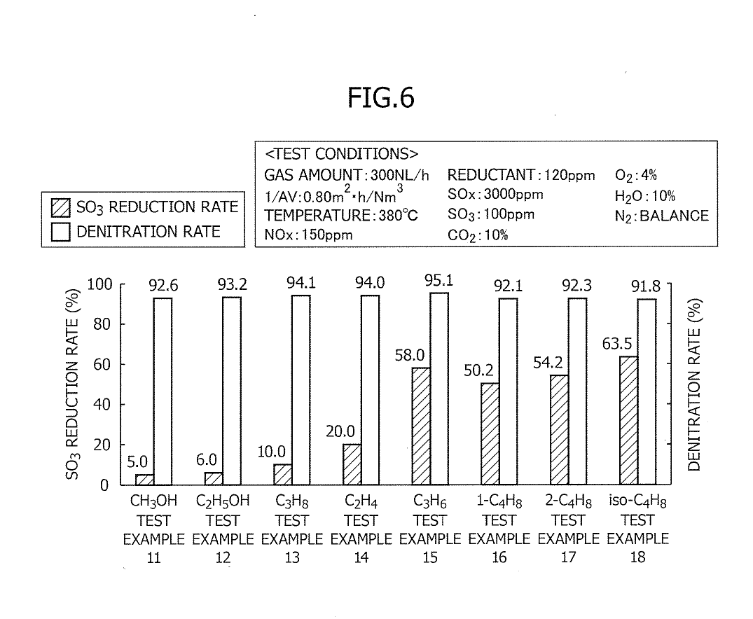

By using Test Examples 11 to 18, similarly to Example 1, the SO₃ reductant was added to the combustion flue gas, and the combustion flue gas containing the SO₃ reductant was allowed to flow through the catalyst layer using the SO₃ catalyst installed in the denitration and SO₃ reduction apparatus, and thereby the variation of the concentration of SO₃ and the denitration rate before and after the combustion flue gas had flowed through the catalyst layer was examined. The SO₃ reduction rate and the denitration rate were determined in the following manner. The test results and the test conditions are shown in FIG. 6.

SO₃ reduction rate (%)=(1−concentration of SO₃ at catalyst layer outlet/concentration of SO₃ at catalyst layer inlet)×100

Denitration rate (%)=(1−concentration of NOₓ at catalyst layer outlet/concentration of NOₓ at catalyst layer inlet)×100

FIG. 6 shows the SO₃ reduction rate (%) and the denitration rate (%) at 0.080 m²·h/Nm³ in Test Examples 11 to 18. Referring to FIG. 6, in Test Example 11 using an alcohol, the SO₃ reduction rate was 5.0%, and in Test Example 12 using an alcohol, the SO₃ reduction rate was 6.0%. In contrast, the SO₃ reduction rate of Test Example 13 using a saturated hydrocarbon was 10.0%, while in Test Example 14 using an unsaturated hydrocarbon was 20.0%, which were high values. Further, in Test Examples 15 to 18 using ≧3C unsaturated hydrocarbons, the SO₃ reduction rate of Test Example 15 was 58.0%, the SO₃ reduction rate of Test Example 16 was 50.2%, the SO₃ reduction rate of Test Example 17 was 54.2%, and the SO₃ reduction rate of Test Example 18 was 63.5%, which were very high values.

In Test Examples 11 and 12 using alcohols, the denitration rate of Test Example 11 was 92.6%, and the denitration rate of Test Example 12 was 93.2%. In Test Examples 13 and 14 using a saturated hydrocarbon and an unsaturated hydrocarbon, the denitration rate of Test Example 13 was 94.1%, and the denitration rate of Test Example 14 was 94.0%, which were high values. In Test Examples 15 to 18 using ≧3C unsaturated hydrocarbons, the denitration rate of Test Example 15 was 95.1%, the denitration rate of Test Example 16 was 92.1%, the denitration rate of Test Example 17 was 92.3%, and the denitration rate of Test Example 18 was 91.8%, which were sufficiently high values.

From the results of Examples 1 and 2, it was found that by using a hydrocarbon including the elements H and C as the SO₃ reductant, the concentration of SO₃ in the combustion flue gas at the inlet of the catalyst layer decreased. It was also found that by using C₃H₈, C₂H₄, C₃H₆, or C₄H₈, i.e., a saturated hydrocarbon or an unsaturated hydrocarbon, as the SO₃ reductant, the concentration of SO₃ in the combustion flue gas decreased more compared with the case of using alcohols such as CH₃OH and C₂H₅OH. Further, it was found that among them, by using C₂H₄, C₃H₆, or C₄H₈, i.e., an unsaturated hydrocarbon, as the SO₃ reductant, the concentration of SO₃ in the combustion flue gas could be efficiently decreased. It was found that by using ≧3C unsaturated hydrocarbons as the SO₃ reductant, in particular, the concentration of SO₃ in the combustion flue gas remarkably decreased. It was estimated that this was because the decomposition activity of ≧3C unsaturated hydrocarbons is high and the intermediate body thereof has high reactivity with SO₃.

### Example 3

A catalyst having another composition was prepared and the effect of reducing SO₃ into SO₂ and the denitration rate depending on the catalyst composition was examined.

### (Preparation of Catalyst F)

Ti(O-iC₃H₇)₄, a Ti alkoxide, and Ce(OCH₃)₄, a Ce alkoxide, were mixed at a ratio of 88:12 (wt. %) (as TiO₂, CeO₂, respectively), the mixture was added to 80° C. water for hydrolysis, then the reaction mixture was stirred and matured, the produced sol was filtered, and the obtained gelled product was washed, dried, and heated and fired at 500° C. for 5 hours to obtain a powder of TiO₂—Ce₂O₃ complex oxide (TiO₂—Ce₂O₃ powder). The obtained powder was used as the catalyst F.

### (Preparation of Catalyst G)

A catalyst including zirconia (ZrO₂) only was prepared. A powder of zirconium oxychloride (ZrOCl₂) was fired at 500° C. for 5 hours, and the obtained powder was used as the catalyst G.

### (Preparation of Catalyst H)

A catalyst including cerium oxide (Ce₂O₃) only was prepared. A powder of cerium nitrate (Ce(NO₃)₂) was fired at 500° C. for 5 hours, and the obtained powder was used as the catalyst H.

### (Preparation of Test Examples 19 to 24)

80 wt. % water was added respectively to the TiO₂—SiO₂ powder of the catalysts D and B, the TiO₂—ZrO₂ powder of the catalyst C, and the catalysts F, G, and H, of which the amount was 20 wt. %, respectively, and the mixture was pulverized by wet ball mill to obtain wash coat slurry, and then the slurry was coated onto a ceramics base material including kaolinite as its main component, and the obtained pieces were used as Test Examples 19 to 24. Table 1 shows the composition of the respective Test Examples. In Table 1, for the coating amount average value, an average value was used which was obtained by measurement of 2 samples by using values calculated by dividing a carriage amount, which had been obtained based on the difference in the weight before and after the coating by the surface area of the base material.

TABLE 1
Test Example Composition 1

| | Catalyst | Coating amount | Charged material |
|---|---|---|---|
| | composition | average value | shape |
| Test Example 19 | TiO₂ | 106 | 3 × 3 × 60 × 2 |
| Test Example 20 | TiO₂—SiO₂ | 108 | |
| Test Example 21 | TiO₂—ZeO₂ | 127 | |
| Test Example 22 | TiO₂—Ce₂O₃ | 127 | |
| Test Example 23 | ZrO₂ | 102 | |
| Test Example 24 | Ce₂O₃ | 103 | |

### (SO₃ Removal Test VI)

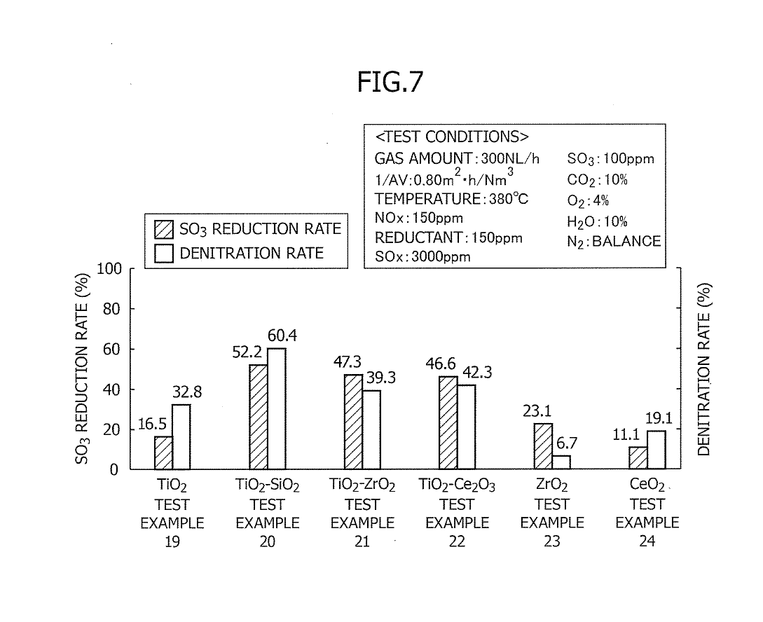

The capability of reducing SO₃ when propylene (C₃H₆) was used as the SO₃ reductant was examined for the respective Test Examples. Similarly to Example 2, the SO₃ reductant was added to the combustion flue gas, and the combustion flue gas including the SO₃ reductant was allowed to flow through the catalyst layer using the SO₃ catalyst installed in the denitration and SO₃ reduction apparatus, and thereby variation of the concentration of SO₃ before and after the combustion flue gas had flowed through the catalyst layer was examined. The test results and the test conditions are shown in FIG. 7.

FIG. 7 shows the SO₃ reduction rate (%) and the denitration rate (%) at 0.080 m²·h/Nm³ in Test Examples 19 to 24. Referring to FIG. 7, in Test Examples 19, 23, and 24 in which an oxide including a single component, the SO₃ reduction rate of Test Example 19 was 16.5%, the SO₃ reduction rate of Test Example 23 was 23.1%, and the SO₃ reduction rate of Test Example 24 was 11.1%. On the other hand, in Test Examples 20 to 22 in which a complex oxide containing TiO₂ was used, the SO₃ reduction rate of Test Example 20 was 52.2%, the SO₃ reduction rate of Test Example 21 was 47.3%, and the SO₃ reduction rate of Test Example 22 was 46.6%.

In addition, in Test Examples 19, 23, and 24 in which an oxide including a single component was used, the denitration rate of Test Example 19 was 32.8%, the denitration rate of Test Example 23 was 6.7%, and the denitration rate of Test Example 24 was 19.1%. On the other hand, in Test Examples 20 to 22 in which a complex oxide containing TiO₂ was used, the denitration rate of Test Example 20 was 60.4%, the denitration rate of Test Example 21 was 39.3%, and the denitration rate of Test Example 22 was 42.3%.

From these results, in all of Test Examples 19 to 24, the concentration of SO₃ in the combustion flue gas at the inlet of the catalyst layer decreased. In Test Examples 20 to 22 in which the TiO₂—SiO₂ powder, TiO₂—ZrO₂ powder, or the TiO₂—Ce₂O₃ powder was used, the SO₃ reduction rate was higher than that in Test Examples 19, 23, and 24 in which the TiO₂ powder, ZrO₂ powder, or the Ce₂O₃ powder was used. In addition, in Test Examples 19, 23, and 24 in which an oxide including a single component was used, the reduction rate of Test Example 19 in which the TiO₂ powder was used was high, and the reduction rate of Test Example 23 in which the ZrO₂ powder was used was the highest. In addition, among Test Examples 20 to 22 in which the complex oxide was used, the SO₃ reduction rate of Test Example 19 using the TiO₂—SiO₂ powder was the most remarkable. From these results, it was found that by using a complex oxide containing TiO₂, in particular, the SO₃ reduction rate could be high. It was estimated that the above results were obtained due to increase of the solid acid amount, which occurred due to the use of the complex oxide.

### (Determination of the Solid Acid Amount)

Then the relationship between the solid acid amount and the SO₃ reduction rate was examined. The solid acid amount in Test Examples 19 to 24 was measured by a pyridine thermal adsorption desorption method. More specifically, the same amount of 25 mg of a powder of quartz was added to the respective Test Example and the mixture was fixed in a quartz glass tube with Kaowool. The quartz glass tube was installed in an electric furnace installed in FID gas chromatography, then the reaction mixture was treated under the condition of the temperature of 450° C. for 30 minutes in a helium (He) gas stream. Then the electric furnace was maintained at 150° C., pyridine was injected by 0.5 μl for 4 to 6 times until saturation in terms of pulse was obtained, and the pyridine was adsorbed to the respective Test Examples. Then the temperature of the electric furnace was raised at the rate of 30° C./min, the desorbed pyridine was measured by FID gas chromatography, and the solid acid amount of the respective Test Examples was determined based on the obtained peak value in TPD spectrum.

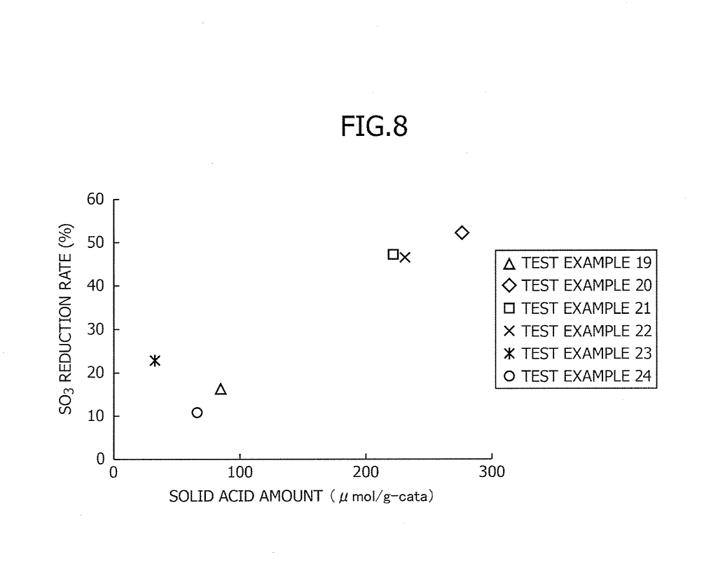

FIG. 8 shows the relationship between the solid acid amount (μmol/g.cata) and the SO₃ reduction rate (%) measured in the respective Test Examples 19 to 24. Referring to FIG. 8, the larger the solid acid amount of the catalyst was, the higher the SO₃ reduction rate was. In particular, in Test Examples in which the solid acid amount was 200 μmol/g.cata to 300 μmol/g.cata, the SO₃ reduction rate was high. From these results, it was found that it became more effective for reduction of SO₃ as the solid acid amount increased.

### Example 4

A catalyst having yet another composition was prepared and the effect of an active metal for reducing SO₃ into SO₂ and the denitration rate were examined.

### (Preparation of Catalyst H)

Ti(O-iC₃H₇)₄, a Ti alkoxide, and Si(OCH₃)₃, a Si alkoxide, were mixed at a ratio of 95:5 (wt. %) (as TiO₂, SiO₂, respectively), the mixture was added to 80° C. water for hydrolysis, then the reaction mixture was stirred and matured, the produced sol was filtered, and the obtained gelled product was washed, dried, and heated and fired at 500° C. for 5 hours to obtain a powder of TiO₂—SiO₂ complex oxide (TiO₂—SiO₂ powder). The obtained powder was used as the catalyst H.

### (Preparation of Test Examples 25 to 32)

80 wt. % water was added to 20 wt. % catalyst H, and the mixture was pulverized by wet ball mill to obtain wash coat slurry, and then the slurry was coated onto a ceramic base material including kaolinite as its main component, and the obtained piece was used as Test Example 25. In addition, a predetermined amount of the respective solution of sulfate or nitrate used as the raw material of V₂O₅, MoO₃, Ag, WO₃, Mn₂O₃, NiO, and Co₃O₄, respectively, was added to the catalyst H, the solution was impregnated and the component was carried, then the obtained product was coated onto the ceramic base material similarly to Test Example 25, and the resultant product was used as Test Examples 26 to 32. The coating amount for each Test Example was measured similarly to Example 3, i.e., about 100 g/m². Table 2 shows the composition of the respective Test Examples.

TABLE 2
Test Example Composition 2

| | Catalyst composition | | |
|---|---|---|---|
| | Active | | Load of active |
| | Component | Carrier | component |
| Test Example 25 | — | TiO₂—SiO₂ | — |
| Test Example 26 | V₂O₅ | | 3.0/3.5 |
| Test Example 27 | MoO₃ | | 3.0/5.5 |
| Test Example 28 | Ag | | 0.7/1.0 |
| Test Example 29 | WO₃ | | 3.0/8.9 |
| Test Example 30 | Mn₂O₃ | | 3.0/3.0 |
| Test Example 31 | NiO | | 3.0/2.9 |
| Test Example 32 | Co₃O₄ | | 3.0/3.1 |

### (SO₃ Removal Test V)

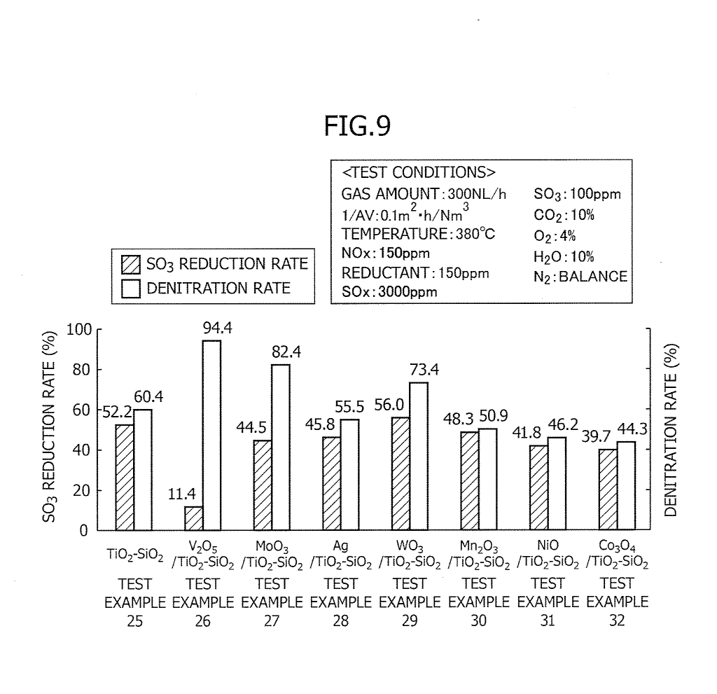

The capability of reducing SO₃ when propylene (C₃H₆) was used as the SO₃ reductant was examined for the respective Test Examples. Similarly to Example 2, the SO₃ reductant was added to the combustion flue gas, and the combustion flue gas including the SO₃ reductant was allowed to flow through the catalyst layer using the SO₃ catalyst installed in the denitration and SO₃ reduction apparatus, and thereby variation of the concentration of SO₃ before and after the combustion flue gas had flowed through the catalyst layer was examined. The test results and the test conditions are shown in FIG. 9.

FIG. 9 shows the SO₃ reduction rate (%) and the denitration rate (%) at 0.1 m²·h/Nm³ in Test Examples 24 to 32. Referring to FIG. 9, the SO₃ reduction rate of Test Example 25 was 52.2%. On the other hand, the SO₃ reduction rate of Test Example 26 was 11.4%, the SO₃ reduction rate of Test Example 27 was 44.5%, and the SO₃ reduction rate of Test Example 28 was 45.8%. The SO₃ reduction rate of Test Example 29 was 56.0%, the SO₃ reduction rate of Test Example 30 was 48.3%, the SO₃ reduction rate of Test Example 31 was 41.8%, and the SO₃ reduction rate of Test Example 32 was 39.7%.

The denitration rate of Test Example 25 was 60.4%. On the other hand, the denitration rate of Test Example 26 was 94.4%, the denitration rate of Test Example 27 was 82.4%, the denitration rate of Test Example 28 was 55.5%, the denitration rate of Test Example 29 was 73.4%, the denitration rate of Test Example 30 was 50.9%, the denitration rate of Test Example 31 was 46.2%, and the denitration rate of Test Example 32 was 44.3%.

From these results, it was verified that the SO₃ reduction effect and the denitration effect could be obtained by using C₃H₆ as the SO₃ reductant for all Test Examples in which V₂O₅, MoO₃, Ag, WO₃, Mn₂O₃, MnO₂, NiO, or Co₃O₄ was carried. In Test Examples 27 to 32 in which MoO₃, Ag, WO₃, Mn₂O₃, MnO₂, NiO, or Co₃O₄ was carried, a high SO₃ reduction effect was observed. The SO₃ reduction effect and the denitration effect were observed particularly in Test Example 29 among them, in which WO₃ was carried. From this result, it was found that a catalyst impregnated with WO₃ was effective.

### Example 5

A catalyst having yet another composition was prepared and both the SO₃ reduction capability and the denitration capability were evaluated.

### (Preparation of Test Examples 33 to 37)

A catalyst I, in which V₂O₅—WO₃ was carried on TiO₂, was prepared in a similar manner as the case of preparing the catalyst B except that 0.3 wt. % V₂O₅ was carried by using ammonium metavanadate and 9 wt. % WO₃ was simultaneously carried by using ammonium paratungstate, per 100 wt. % of complex oxide, and the catalyst I was used as Test Example 33.

A catalyst J, in which V₂O₅—WO₃ was carried on a TiO₂—SiO₂ complex oxide, was prepared in a similar manner as the case of preparing the catalyst B except that 0.3 wt. % V2O5 was carried and 9 wt. % WO₃ was simultaneously carried, per 100 wt. % of complex oxide, and the catalyst J was used as Test Example 33. The catalyst J was coated with metallosilicate at 25 g/m² to obtain a catalyst K, and the obtained catalyst K was used as Test Example 35. The catalyst B was used as Test Example 36. A catalyst L, in which V₂O₅—WO₃ was carried on TiO₂, was prepared in a similar manner as the case of preparing the catalyst B except that 0.7 wt. % V₂O₅ was carried and 9 wt. % WO₃ was simultaneously carried, per 100 wt. % of complex oxide, and the catalyst L was used as Test Example 37. FIG. 3 shows the composition of the respective Test Examples.

TABLE 3
Test Example Composition 3

| | Catalyst composition | | |
|---|---|---|---|
| | | Active | |
| | Coating layer | Component | Carrier |
| Test Example 33 | — | V₂O₅—WO₃ | TiO₂ |
| Test Example 34 | — | V₂O₅—WO₃ | TiO₂—SiO₂ |
| Test Example 35 | Metallosilicate | V₂O₅—WO₃ | TiO₂—SiO₂ |
| Test Example 36 | — | WO₃ | TiO₂ |
| Test Example 37 | — | WO₃ | TiO₂—SiO₂ |

### (SO₃ Removal Test VI)

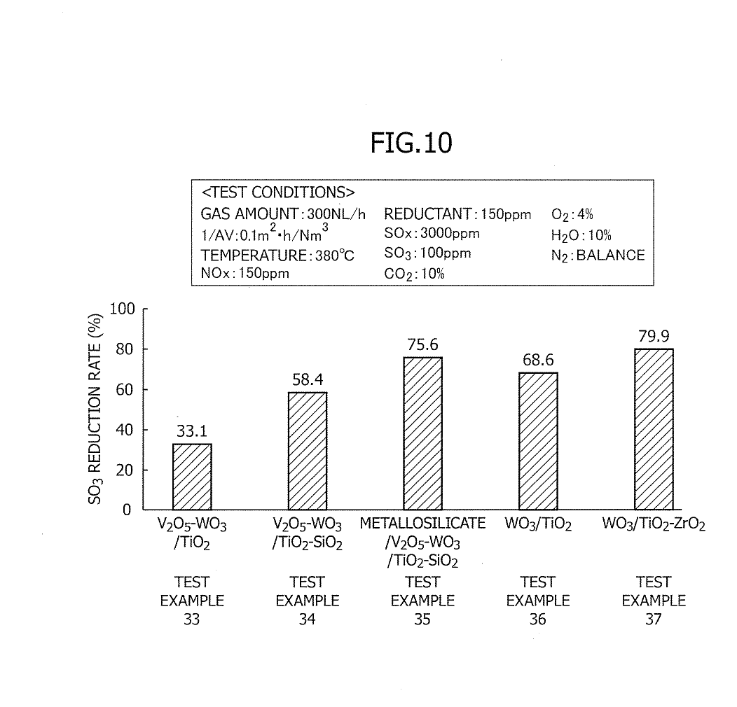

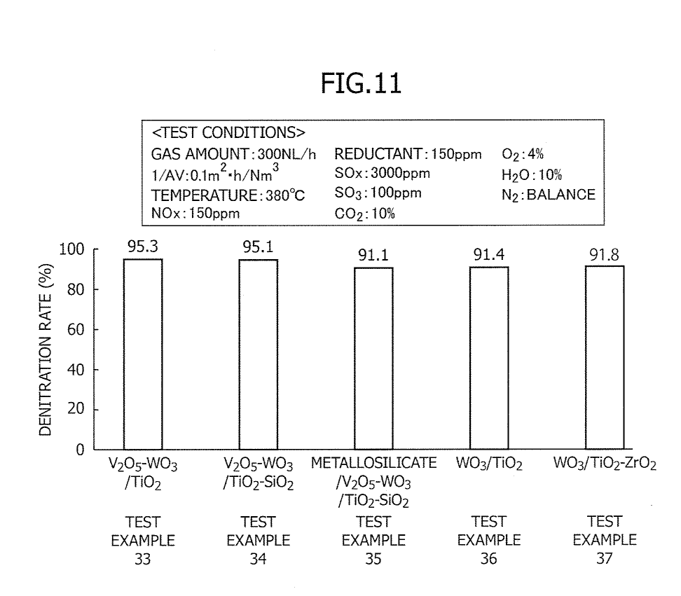

The capability of reducing SO₃ when propylene (C₃H₆) was used as the SO₃ reductant was examined for the respective Test Examples. Similarly to Example 2, the SO₃ reductant was added to the combustion flue gas, and the combustion flue gas including the SO₃ reductant was allowed to flow through the catalyst layer using the SO₃ catalyst installed in the denitration and SO₃ reduction apparatus, and thereby variation of the concentration of SO₃ before and after the combustion flue gas had flowed through the catalyst layer and the denitration rate were examined. The test results and the test conditions are shown in FIGS. 10 and 11.

FIG. 10 shows the SO₃ reduction rate (%) at 0.1 (1/AV: m²·h/Nm³) in Test Examples 33 to 37. Referring to FIG. 10, the SO₃ reduction rate of Test Example 33 was 33.3%. On the other hand, the SO₃ reduction rate of Test Example 34 was 58.4%, the SO₃ reduction rate of Test Example 35 was 75.6%, the SO₃ reduction rate of Test Example 36 was 68.6%, and the SO₃ reduction rate of Test Example 37 was 79.9%.

FIG. 11 shows the rate of denitration (%) from the combustion flue gas at 0.10 (1/AV: m²·h/Nm³) in Test Examples 33 to 37. Referring to FIG. 11, the denitration rate of Test Example 33 was 95.3%, the denitration rate of Test Example 34 was 95.1%, the denitration rate of Test Example 35 was 91.1%, the denitration rate of Test Example 36 was 91.4%, and the denitration rate of Test Example 37 was 91.8%.

From these results, it was found that in all these Test Examples, both the high SO₃ reduction capability and the high denitration capability could be obtained. In addition, in Test Examples 34 to 37, a high performance of reducing SO₃ to SO₂ higher than that of Test Example 33 was observed as expected.

### INDUSTRIAL APPLICABILITY

According to the flue gas treatment method and the denitration and SO₃ reduction apparatus of the present invention, it is made possible to denitrate NOₓ in the combustion flue gas and reduce the concentration of SO₃ in the combustion flue gas at the same time at treatment costs lower than those conventionally.

### REFERENCE SIGNS LIST

1 Furnace
2 Flue gas chimney
3 ECO
4 ECO bypass
5, 15, 25 Denitration and SO₃ reduction apparatus
6, 16, 26 First injection device
7, 17, 27 Second injection device
8 Catalyst layer
18, 28 First catalyst layer
19, 29 Second catalyst layer

1. A flue gas treatment method comprising the steps of:
adding a 3C-5C olefinic hydrocarbon (unsaturated hydrocarbon) to a combustion flue gas including SO₃ as well as NOₓ as a first additive; and then,
bringing the combustion flue gas into contact with a catalyst which includes an oxide constituted by one or more of elements selected from the group consisting of Ti, Si, Zr, and Ce and/or a mixed oxide and/or a complex oxide constituted by two or more of elements selected from the group as a carrier and which does not include a noble metal, and thereby SO₃ is treated by reduction into SO₂.

2. The flue gas treatment method according to claim 1, wherein the 3C-5C olefinic hydrocarbon (unsaturated hydrocarbon) is one or more selected from the group consisting of C₃H₆, C₄H₈, and C₅H₁₀.

3. The flue gas treatment method according to claim 2, wherein the C₄H₈ and C₅H₁₀ are a geometric isomer or a racemic body of either one of them.

4. The flue gas treatment method according to claim 1, wherein the carrier includes a mixed oxide and/or a complex oxide including one or more selected from the group consisting of TiO₂—SiO₂, TiO₂—ZrO₂, and TiO₂—CeO₂.

5. The flue gas treatment method according to 4 claim 1, wherein the catalyst is a catalyst in which a metal oxide including one or more selected from the group consisting of V₂O₅, WO₃, MoO₃, Mn₂O₃, MnO₂, NiO, and Co₃O₄ is carried on the complex oxide as the carrier.

6. The flue gas treatment method according to claim 5, wherein a metallosilicate-base complex oxide, in which at least a part of Al and/or Si in a zeolite crystal structure is substituted with one or more selected from the group consisting of Ti, V, Mn, Fe, and Co, is coated onto the catalyst.

7. The flue gas treatment method according to claim 1, wherein a treatment for reducing SO₃ into SO₂ is performed in a temperature range of 250° C. to 450° C.

8. The flue gas treatment method according to claim 7, wherein a treatment for reducing SO₃ into SO₂ is performed in a temperature range of 300° C. to 400° C.

9. An SO₃ reduction apparatus comprising:
a first injection device configured to obtain add a first additive to a combustion flue gas containing SO₃ as well as NOₓ; and
a catalyst layer including a catalyst through which the combustion flue gas is allowed to flow,
wherein the first additive is a 3C-5C olefinic hydrocarbon (unsaturated hydrocarbon),
wherein the catalyst does not include a noble metal and includes an oxide including one or more of elements selected from the group consisting of Ti, Si, Zr, and Ce and/or a mixed oxide and/or a complex oxide including two or more of elements selected from the group as a carrier, and
wherein the SO₃ reduction apparatus is configured to perform a treatment for reducing SO₃ to SO₂.

10. The SO₃ reduction apparatus according to claim 9, wherein the 3C-5C olefinic hydrocarbon (unsaturated hydrocarbon) is one or more selected from the group consisting of C₃H₆, C₄H₈, and C₅H₁₀.

11. The SO₃ reduction apparatus according to claim 10, wherein the C₄H₈ and C₅H₁₀ are a geometric isomer or a racemic body of either one thereof.

12. The SO₃ reduction apparatus according to claim 9, wherein the carrier includes a mixed oxide and/or a complex oxide including one or more selected from the group consisting of TiO₂—SiO₂, TiO₂—ZrO₂, and TiO₂—CeO₂.

13. The SO₃ reduction apparatus according to claim 9, wherein the catalyst is a catalyst in which a metal oxide including one or more selected from the group consisting of V₂O₅, WO₃, MoO₃, Mn₂O₃, MnO₂, NiO, and Co₃O₄ is carried on the complex oxide as the carrier.

14. The SO₃ reduction apparatus according to claim 9, wherein the catalyst layer includes:
a first catalyst layer arranged on a back stream side of the first injection device and configured to reduce the concentration of SO₃; and
a second catalyst layer arranged on a back stream side of a second injection device arranged close to the first injection device and configured to add NH₃ to the combustion flue gas as a second additive, the second catalyst layer being configured to perform denitration, and
wherein the first catalyst layer is arranged on a front stream side or a back stream side of the second catalyst layer.
